(19) United States
(12) Patent Application Publication
(10) Pub. No.: US 2013/0300268 A1
(43) Pub. Date: Nov. 14, 2013

(54) DOOR ASSEMBLY FOR AN APPLIANCE

(71) Applicants: Brandon KG Schaefer, Louisville, KY (US); Justin Paul Mudd, Louisville, KY (US); Suzanne Marie Damaske, Taylorsville, KY (US); Keith Eugene Kropf, Louisville, KY (US)

(72) Inventors: Brandon KG Schaefer, Louisville, KY (US); Justin Paul Mudd, Louisville, KY (US); Suzanne Marie Damaske, Taylorsville, KY (US); Keith Eugene Kropf, Louisville, KY (US)

(73) Assignee: GENERAL ELECTRIC COMPANY, Schenectady, NY (US)

(21) Appl. No.: 13/466,218

(22) Filed: May 8, 2012

(51) Int. Cl. A47L 15/42; E06B 7/00; E06B 3/38; E06B 3/70

(52) U.S. Cl. 312/228; 49/381; 49/70; 49/399

(57) ABSTRACT

A door assembly for an appliance, e.g., a dishwasher appliance, is provided. The door assembly includes an inner door panel and an outer door panel. The inner door panel is secured to the outer door panel with clips. With such a construction, the door assembly can have an aesthetically pleasing appearance to consumers.

### FIELD OF THE INVENTION

The present subject matter relates generally to doors for appliances, e.g., dishwasher appliances.

### BACKGROUND OF THE INVENTION

Dishwasher appliances generally include a tub that defines a wash chamber for receipt of articles for washing. A door provides for selective access to the wash chamber. For example, the door can be rotatably mounted to the wash tub with a hinge. The door can selectively adjust between an open and a closed position by rotating about the hinge in order to permit access to the wash chamber.

In certain dishwasher appliances, the door can include an inner door panel and an outer door panel that are coupled together to form the door assembly. For example, fasteners can be inserted through the inner door panel into the outer door panel in order to secure the inner and outer door panels together. However, using fasteners to couple the inner and outer door panels together can have drawbacks. For example, the heads of the fasteners can be visible to a user. Such fastener heads can have an unattractive appearance that detracts from the overall aesthetic appeal of the dishwasher appliance. In addition, the fasteners can corrode over time and leave an unattractive residue on the inner door panel. Also, the fasteners can deform portions of the inner door panel around the fasteners such that the inner door panel has an undesirable, wavy appearance. Further, during operation of the dishwasher appliance, food particles can collect around the fasteners leading to an unsightly appearance.

Accordingly, a door assembly for an appliance with features for improved mounting of an inner door panel to an outer door panel would be useful. In particular, a door assembly for an appliance with features for mounting an inner door panel to an outer door panel without unsightly fasteners would be useful.

### BRIEF DESCRIPTION OF THE INVENTION

Aspects and advantages of the invention will be set forth in part in the following description, or may be apparent from the description, or may be learned through practice of the invention.

A door assembly for an appliance is provided. The door assembly includes an inner door panel and an outer door panel. The inner door panel is secured to the outer door panel with clips. With such a construction, the door assembly can have an aesthetically pleasing appearance to consumers.

In a first exemplary embodiment, a door assembly for an appliance is provided. The door assembly includes an outer door panel and an inner door panel. The outer door panel defines a first plurality of holes and a second plurality of holes. The first plurality of holes is dispersed on a first side of said outer door panel along a vertical direction. The second plurality of holes is dispersed on a second side of the outer door panel along the vertical direction. A first plurality of clips is mounted on a first side of the inner door panel. The first plurality of clips is dispersed along the vertical direction such that each one of the first plurality of clips is received within a respective one of the first plurality of holes of the outer door panel. A second plurality of clips is mounted on a second side of the outer door panel. The second plurality of clips is dispersed along the vertical direction such that each one of the second plurality of clips is received within a respective one of the second plurality of holes of the outer door panel.

In a second exemplary embodiment, a dishwasher appliance is provided. The dishwasher appliance includes a tub that defines a wash chamber for receipt of articles for cleaning A door assembly is mounted to the tub and configured for permitting selective access to the wash chamber of the tub. The door assembly includes an outer door panel and an inner door panel. The outer door panel has a first side and a second side spaced apart along a horizontal direction. A first flange is positioned at the first side of the outer door panel. The first flange is spaced apart from the outer door panel along a transverse direction. The first flange defines a first plurality of holes. A second flange is positioned at the second side of the outer door panel. The second flange is spaced apart from the outer door panel along the transverse direction. The second flange defines a second plurality of holes. The inner door panel has a first side and a second side spaced apart along the horizontal direction. A first plurality of clips is mounted on the first side of the inner door panel in a complementary manner to the first plurality of holes of the first flange. A second plurality of clips is mounted on the second side of the inner door panel in a complementary manner to the second plurality of holes of the second flange. Each one of the first plurality of clips is configured for receipt within a respective one of the first plurality of holes of the first flange, and each one of the second plurality of clips is configured for receipt within a respective one of the second plurality of holes of the second flange in order to mount the inner door panel to the outer door panel.

In a third exemplary embodiment, a door assembly for an appliance is provided. The door assembly includes an outer door panel and an inner door panel. The inner door panel defines a first plurality of holes and a second plurality of holes. The first plurality of holes is dispersed on a first side of said inner door panel along a vertical direction. The second plurality of holes is dispersed on a second side of the inner door panel along the vertical direction. A first plurality of clips is mounted on a first side of the outer door panel. The first plurality of clips is dispersed along the vertical direction such that each one of the first plurality of clips is received within a respective one of the first plurality of holes of the inner door panel. A second plurality of clips is mounted on a second side of the outer door panel. The second plurality of clips is dispersed along the vertical direction such that each one of the second plurality of clips is received within a respective one of the second plurality of holes of the inner door panel.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a front view of a dishwasher appliance according to an exemplary embodiment of the present subject matter with an exemplary embodiment of a door assembly mounted to a cabinet of the dishwasher appliance.

FIG. 2 provides a side view of the dishwasher appliance of FIG. 1 with a portion of the cabinet removed to reveal an interior of the dishwasher appliance.

FIG. 3 illustrates an exploded view of the door assembly of FIG. 1.

FIG. 4 illustrates an exploded view of an exemplary embodiment of an inner door panel of the door assembly of FIG. 3.

FIG. 5 provides a perspective view of an exemplary embodiment of one of a plurality of clips of the inner door panel of FIG. 4.

FIG. 6 provides a rear perspective view of an exemplary embodiment of an outer door panel.

FIGS. 7 and 9 illustrate front perspective views of the door assembly of FIG. 3 in various stages of mounting the outer door panel to the inner door panel.

FIGS. 8 and 10 illustrate perspective views of the door assembly of FIG. 3 in various stages of mounting the outer door panel to the inner door panel with one of a plurality of clips.

FIG. 11 provides a rear perspective view of a portion of the door assembly of FIG. 9 taken along the 11-11 line of FIG. 9.

FIGS. 12 and 13 illustrate rear perspective views of another exemplary embodiment of an inner door panel and, in particular, a plurality of clips being mounted to the inner door panel.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

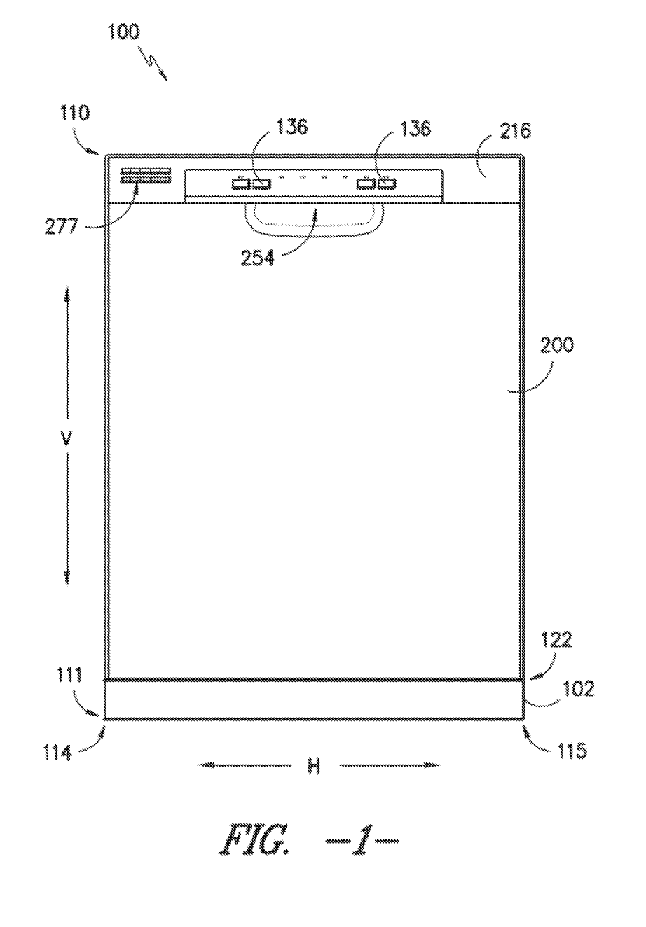

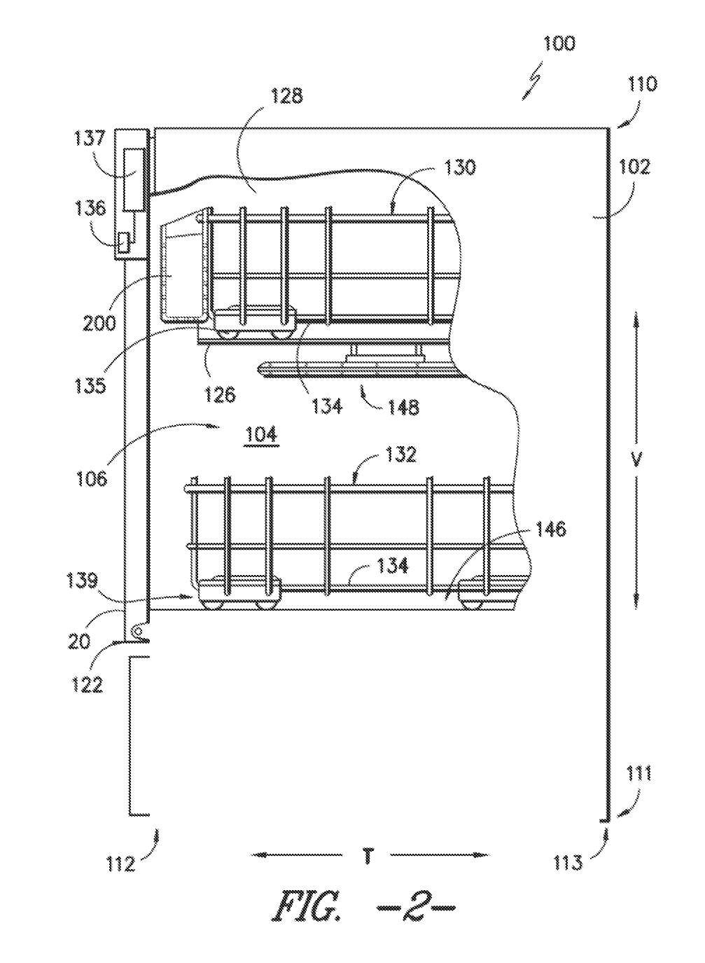

FIGS. 1 and 2 depict an exemplary domestic dishwasher 100 that may be configured in accordance with aspects of the present disclosure. The dishwasher 100 includes a cabinet 102 having a tub 104 therein that defines a wash chamber 106. The tub 104 includes a door assembly 200 hinged at its bottom 122 for movement between a normally closed configuration (shown in FIGS. 1 and 2), wherein the wash chamber 106 is sealed shut (e.g., for washing operation), and an open configuration (e.g., for loading and unloading of articles from the dishwasher).

As may be seen in FIG. 1, dishwasher appliance 100 extends between a top 110 and a bottom 111 along a vertical direction V and also extend between a first side 114 and a second side 115 along a horizontal direction H. As may be seen in FIG. 2, dishwasher appliance 100 also extends between a front 112 and a back 113 along a transverse direction T. Transverse direction T is substantially perpendicular to horizontal and vertical directions H, V. Thus, vertical direction V, horizontal direction H, and transverse direction T are orthogonally oriented such that vertical direction V, horizontal direction H, and transverse direction T form an orthogonal directional system.

Turning to FIG. 2, guide rails 126 are mounted on tub side walls 128 and accommodate upper and lower roller-equipped rack assemblies 130, 132. Each of the upper and lower racks 130, 132 is fabricated from lattice structures that include a plurality of elongated members 134. Each rack 130, 132 is adapted for movement between an extended loading position (not shown) in which the rack is substantially positioned outside the wash chamber 106, and a retracted position (shown in FIGS. 1 and 2) in which the rack is located inside the wash chamber 106.

A silverware basket 150 is removably mounted to door assembly 200. However, silverware basket 150 may also be selectively attached to other portions of dishwasher 100, e.g., lower rack 132. Silverware rack 150 is configured for receipt of silverware, utensils, and the like, that are too small to be accommodated by the upper and lower racks 130, 132.

The dishwasher 100 further includes a lower spray assembly 144 that is mounted within a lower region 146 of the wash chamber 106 and above a tub sump portion 142 so as to be in relatively close proximity to the lower rack 132. A mid-level spray assembly 148 is located in an upper region of the wash chamber 106 and may be located in close proximity to upper rack 130. Additionally, an upper spray assembly (not shown) may be located above the upper rack 130.

The lower and mid-level spray assemblies 144, 148 and the upper spray assembly are fed by a fluid circulation assembly (not shown) for circulating water and dishwasher fluid in the tub 104. The fluid circulation assembly may be located in a machinery compartment 140 located below the bottom sump portion 142 of the tub 104, as generally recognized in the art. Each spray assembly includes an arrangement of discharge ports or orifices for directing washing liquid onto dishes or other articles located in the upper and lower racks 130, 132 and silverware basket 150. The lower and mid-level spray assemblies 144, 148 may be rotatably mounted in wash chamber 106. Accordingly, the arrangement of the discharge ports in at least the lower spray assembly 144 may provide a rotational force by virtue of washing fluid flowing through the discharge ports. The resultant rotation of the lower spray assembly 144 can provide coverage of dishes and other dishwasher contents with a washing spray.

The dishwasher 100 is further equipped with a controller 137 to regulate operation of the dishwasher 100. The controller may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 137 may be positioned in a variety of locations throughout dishwasher 100. In the illustrated embodiment, the controller 137 may be located within a control panel 216 of door assembly 200 as shown. In such an embodiment, input/output (“I/O”) signals may be routed between the control system and various operational components of dishwasher 100 along wiring harnesses that may be routed through the bottom 122 of door assembly 200. Typically, the controller 137 includes a user interface panel 136 through which a user may select various operational features and modes and monitor progress of the dishwasher 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 137 via one or more signal lines or shared communication busses.

It should be appreciated that the present subject matter is not limited to any particular style, model, or other configuration of dishwasher and that the embodiment depicted in FIGS. 1 and 2 is for illustrative purposes only. For example, the present subject matter may be used in dishwasher appliances having other rack configurations. In addition, the present subject matter may be used in other appliances, e.g., refrigerator appliances, freezer appliances, and/or trash compactors.

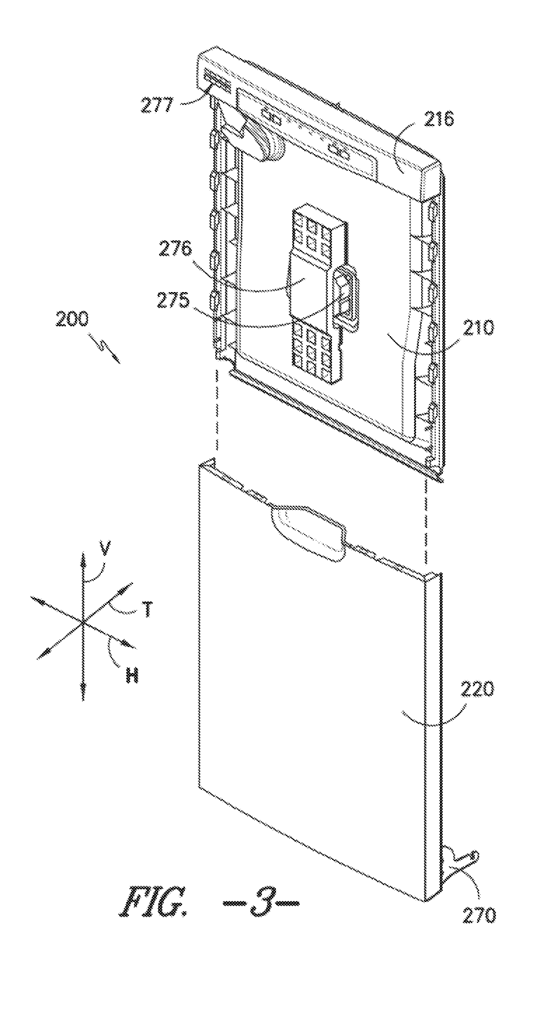

FIG. 3 illustrates an exploded view of door assembly 200. Door assembly 200 includes an inner door panel 210 and an outer door panel 220. As described in greater detail below, inner and outer door panels 210 and 220 are coupled or secured together in order to form door assembly 200.

Inner door panel 210 includes a detergent dispenser 275 mounted to inner door panel 210 with a bracket 276. A user can fill detergent dispenser 275 with detergent prior to starting dishwasher appliance 100 (FIG. 1), and detergent dispenser 275 may dispense such detergent during operation of dishwasher appliance 100. Inner door panel 210 also includes a vent 277 that is in fluid communication with wash chamber 106 of tub 104. Water vapor and/or steam can be directed out of wash chamber 106 through vent 277, e.g., during a drying cycle of dishwasher appliance 100.

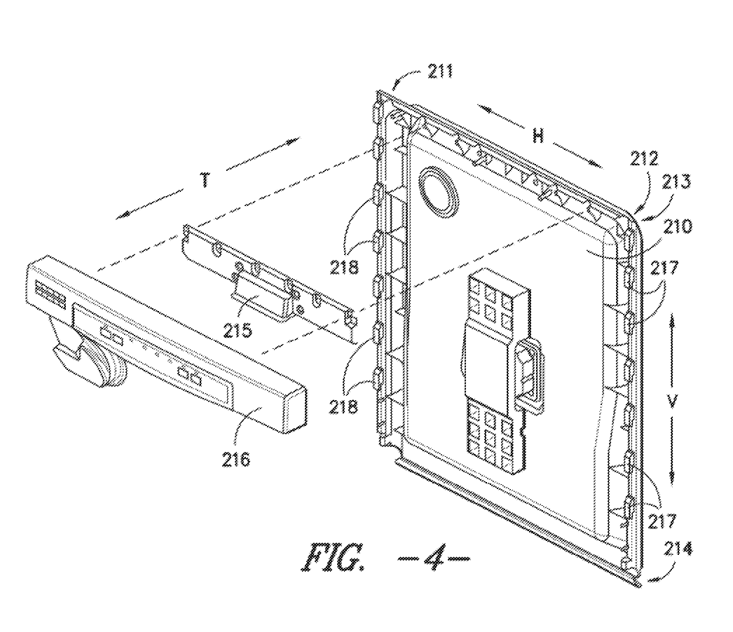

FIG. 4 illustrates an exploded view of inner door panel 210 Inner door panel 210 extends between a first side 211 and a second side 212 along the horizontal direction H when door assembly 200 is in the closed configuration shown in FIG. 1. Also, inner door panel 210 extends between a top 213 and a bottom 214 along the vertical direction V when door assembly 200 is in the closed configuration shown in FIG. 1.

A first plurality of clips 217 and a second plurality of clips 218 are fixed to inner door panel 210. First and second pluralities of clips 217 and 218 are configured for assisting in securing or coupling inner door panel 210 and outer door panel 220 (FIG. 3) together as described in greater detail below. In FIG. 4, inner door panel 210 is constructed of a plastic, and first and second pluralities of clips 217 and 218 are integrally molded to inner door panel 210. However, as will be described in greater detail below, inner door panel 210 may be constructed of other materials (e.g., a metal) where first and second pluralities of clips 217 and 218 are separate components mounted to inner door panel 210.

First plurality of clips 217 is mounted on first side 211 of inner door panel 210. First plurality of clips 217 extend away from inner door panel 210 along the transverse direction T when door assembly 200 (FIG. 1) is in the closed configuration. The clips of first plurality of clips 217 are disposed on first side 211 of inner door panel 210 such that the clips 217 are distributed along the vertical direction V. For example, in FIG. 4, first plurality of clips 217 is substantially uniformly distributed on first side 211 of inner door panel 210 along the vertical direction V. However, first plurality of clips 217 may be distributed along vertical direction V in any suitable manner, e.g., non-uniformly.

Second plurality of clips 218 is mounted on second side 212 of inner door panel 210. Second plurality of clips 218 extend away from inner door panel 210 along the transverse direction T when door assembly 200 (FIG. 1) is in the closed configuration. The clips of second plurality of clips 217 are disposed on second side 212 of inner door panel 210 such that the clips 217 are distributed along the vertical direction V. For example, in FIG. 4, second plurality of clips 218 is substantially uniformly distributed on second side 212 of inner door panel 210 along vertical direction V. However, like first plurality of clips 217, second plurality of clips 218 may be distributed along vertical direction V in any suitable manner, e.g., non-uniformly.

Inner door panel 210 also includes a handle 215 and a control panel 216. To assemble inner door panel 210, handle 215 is mounted or secured to inner door panel 210, e.g., using fasteners such as screws. Alternatively, handle 215 may be fixed or coupled to inner door panel 210 using any suitable mechanism, e.g., snap fit mechanisms, interference fit mechanisms, glue, or combinations thereof. Handle 215 is configured for assisting door assembly 200 (FIG. 1) in adjusting between the open and closed configurations. For example, a user can insert his or her fingers into handle 215 and pull door assembly 200 open (i.e., adjust door assembly 200 from the closed configuration to the open configuration). Because handle 215 is mounted directly to inner door panel 210, handle 215 may function in a more reliable and/or durable manner.

To continue assembling inner door panel 210, control panel 216 is mounted or fixed to handle 215 and/or inner door panel 210. For example, control panel 216 may be secured to handle and/or inner door panel 210 using fasteners, glue, snap fit mechanisms, interference fit mechanisms, any other suitable mechanisms, or combination thereof. As may be seen in FIG. 3, control panel 216 can be mounted over handle 215 such that control panel 216 substantially covers handle 215. Control panel 216 shown herein is generally referred to a “front-control” control panel. However, as will be understood by those skilled in the art, dishwasher appliance 100 (FIG. 1) may be provided with other suitable control panels, e.g., “top-control” control panels.

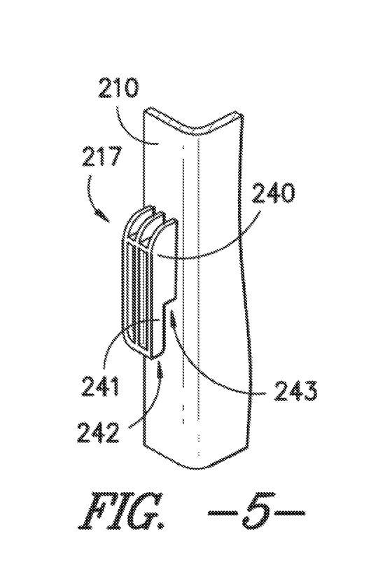

FIG. 5 is a perspective view of one of first plurality of clips 217. It should be understood that the other clips of first plurality of clips 217 and the clips of second plurality of clips 218 may be constructed in the same or a similar manner. As may be seen in FIG. 5, each of the first plurality of clips 217 includes a body portion 240 that is fixed to inner door panel 210. An arm portion 241 is mounted to body portion 240 and extends away from body portion 240 such that a distal end 242 of arm portion 241 is disposed away from body portion 240. Arm portion 241 is also spaced apart from inner door panel 210 such that leg portion 240, arm portion 241, and inner door panel 210 define a slot 243. Slot 243 is sized and configured for receipt of a portion of outer door panel 220 (FIG. 3) as described in greater detail below.

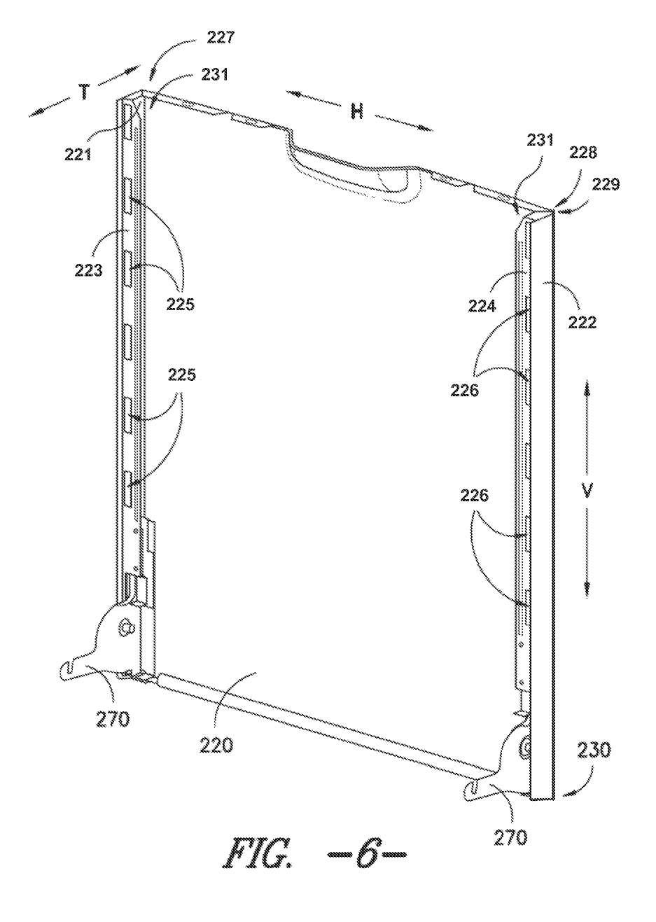

FIG. 6 provides a rear perspective view of outer door panel 220. Like inner door panel 210, outer door panel 220 extends between a first side 227 and a second side 228 along the horizontal direction H when door assembly 200 is in the closed configuration shown in FIG. 1. Also, outer door panel 220 extends between a top 229 and a bottom 230 along the vertical direction V when door assembly 200 is in the closed configuration shown in FIG. 1.

Hinges 270 are mounted to outer door panel 220 at the bottom 230 of outer door panel. Hinges 270 are configured for mounting door assembly 200 (FIG. 1) to cabinet 102 such that door assembly 200 can rotate open and closed. As will be understood by those skilled in the art, other configurations of hinges are available and suitable to mount door assembly 200 to cabinet 102. In addition, door assembly 200 may be mounted to cabinet 102 in any other suitable manner. For example, cabinet 102 may include a drawer with door assembly 200 mounted thereto such that door slides open and closed rather than rotate open and closed.

A first sidewall 221 is mounted to outer door panel 220. First sidewall 221 is positioned at first side 227 of outer door panel 220 and extends away from outer door panel 220 along the transverse direction T. A first flange 223 is mounted to first sidewall 221 and extends away from first sidewall 221 along the horizontal direction H. First flange 223 is spaced apart from outer door panel 220 along the transverse direction T and defines a first plurality of apertures or holes 225. The holes of first plurality of holes 225 are disposed on first flange 223 such that the holes 225 are distributed along the vertical direction V. For example, in FIG. 6, first plurality of holes 225 is substantially uniformly distributed on first flange 223 along vertical direction V. However, first plurality of holes 225 may be distributed along vertical direction V in any suitable manner, e.g., non-uniformly.

A second sidewall 222 is also mounted to outer door panel 220. Second sidewall 222 is positioned at second side 228 of outer door panel 220 and extends away from outer door panel 220 along the transverse direction T. A second flange 224 is mounted to second sidewall 222 and extends away from second sidewall 222 along the horizontal direction H. Second flange 224 is spaced apart from outer door panel 220 along the transverse direction T and defines a second plurality of apertures or holes 226. The holes of second plurality of holes 226 are distributed on second flange 224 such that the holes 226 are dispersed along the vertical direction V. For example, in FIG. 6, second plurality of holes 226 is substantially uniformly distributed on second flange 224 along vertical direction V. However, second plurality of holes 226 may be distributed along vertical direction V in any suitable manner, e.g., non-uniformly.

First and second pluralities of holes 225 and 226 are configured for receipt of first and second pluralities of clips 217 and 218 (FIG. 4). Thus, first and second pluralities of holes 225 and 226 are disposed on first and second flanges 223 and 224 in a complementary manner to first and second pluralities of clips 217 and 218 respectively. By receiving first and second pluralities of clips 217 and 218, first and second pluralities of holes 225 and 226 assist in securing or coupling inner door panel 210 (FIG. 3) and outer door panel 220 together as described in greater detail below.

A pocket 231 is defined by outer door panel 220, first sidewall 221, and second sidewall 222. Pocket 231 is configured for receipt of at least a portion of inner door panel 210 (FIG. 3) as described in greater detail below.

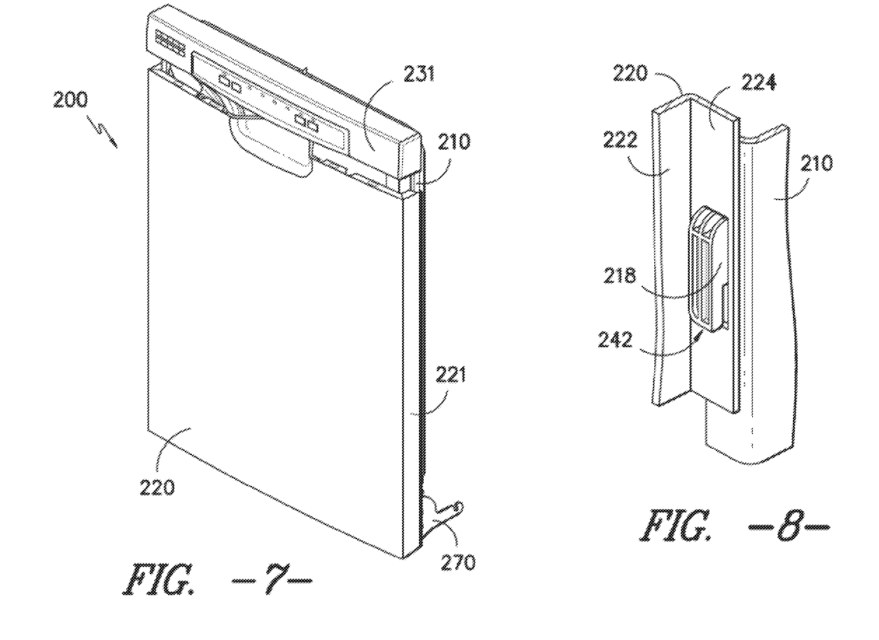

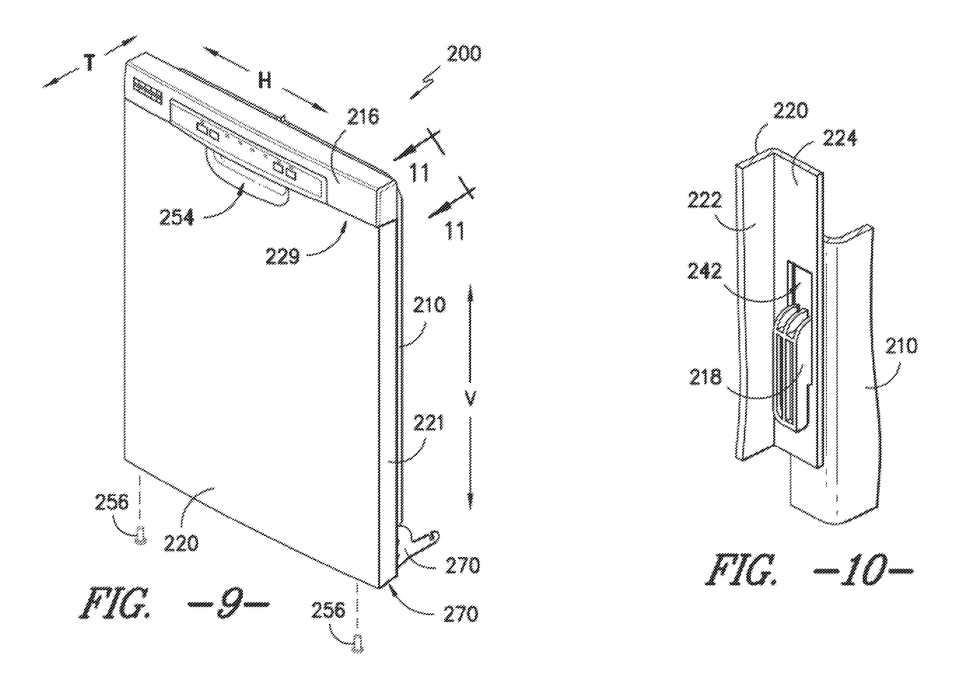

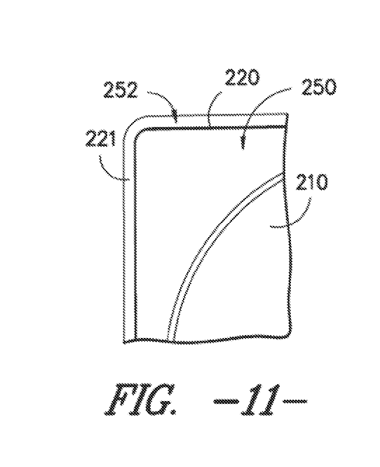

FIGS. 7 and 9 illustrate front perspective views of door assembly 200 in various stages of mounting outer door panel 220 to inner door panel 210. FIGS. 8 and 10 illustrate partial perspective views of one of second plurality of clips 218 mounting outer door panel 220 to inner door panel 210. In particular, FIG. 8 corresponds to a partial perspective view of one of second plurality of clips 218 from FIG. 7, and FIG. 10 corresponds to a partial cross-sectional view of one of second plurality of clips 218 from FIG. 9.

As shown in FIGS. 7 and 9, to secure outer door panel 220 to inner door panel 210, outer door panel 220 is positioned adjacent inner door panel 210 such that at least part of inner door panel 210 is disposed within pocket 231 (FIG. 6) of outer door panel 220. In addition, first plurality of clips 217 (FIG. 4) is received within first plurality of holes 225 (FIG. 6), and second plurality of clips 218 (FIG. 4) is received within second plurality of holes 226 (FIG. 6). As shown in FIGS. 8 and 10, outer door panel 200 may be shifted upwardly along the vertical direction V such that a portion of second flange 224 is received within slot 243 (FIG. 5) of one of second plurality of clips 218. While in FIGS. 8 and 10 only a single clip is shown other clips of first and second pluralities of clips 217 and 218 operate similarly to the clip shown. Accordingly, outer door panel 200 may be shifted upwardly along the vertical direction V such that a portion of first and second flanges 223 and 224 are received within slots 243 (FIG. 5) of first and second pluralities of clips 217 and 218.

After shifting outer door panel 200 upwardly along the vertical direction V, first and second flanges 223 and 224 may be disposed between inner door panel 210 and distal ends 242 of first and second pluralities of clips 217 and 218. For example, as shown in FIG. 10, second flange 224 is disposed between inner door panel 210 and distal end 242 of second clip 218. In such a configuration, first and second pluralities of clips 217 and 218 assist in coupling inner and outer door panels 210 and 220 together such that, e.g., inner and outer door panels 210 and 220 are hindered from separating along the transverse direction T.

As may be seen in FIG. 9, with inner door panel 210 secured to outer door panel 220 with first and second pluralities of clips 217 and 218, top 229 of outer door panel 210 is positioned immediately adjacent control panel 216. Thus, handle 215 (FIG. 4) disposed under control panel 216 may be accessed through a handle recess 254 defined by outer door panel 220. To prevent inner and outer door panels 210 and 220 from sliding along the vertical direction T relative to one another, fasteners 256 may couple inner and outer door panels 210 and 220. Fasteners 256 may be disposed at bottom 122 of door assembly 200 in order to hide or conceal fasteners 256 from a user when dishwasher appliance 100 (FIG. 1) is in use.

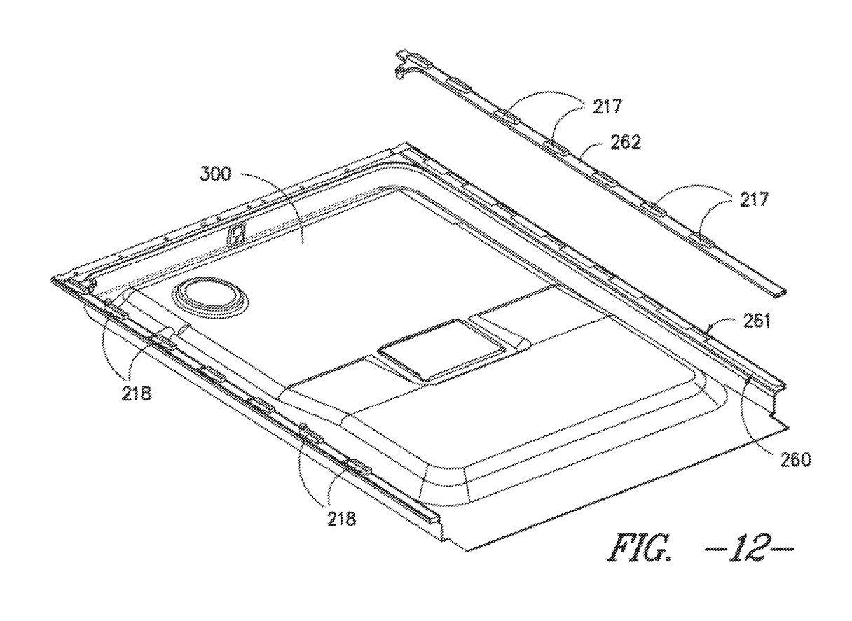

FIG. 11 provides a rear perspective view of a portion of the door assembly of FIG. 9 taken along the 11-11 line of FIG. 9. With outer door panel 220 secured to inner door panel 210, an exterior surface 250 of inner door panel 210 is disposed below a distal end 252 of first sidewall 221 (or second sidewall 222), e.g., along the transverse direction T (FIG. 9). Accordingly, inner door panel 210 is disposed “sub-flush” to outer door panel 220. In other words, exterior surface 250 of inner door panel 210 is disposed within pocket 231 (FIG. 6) of outer door panel 220. Other suitable configurations are available as well. For example, exterior surface 250 of inner door panel 210 may be disposed flush with or above distal end 252 of first sidewall 221.

Inner and outer door panels 210 and 220 are provided by way of example only. Thus, other configurations are considered within the scope of the present subject matter. For example, first and second pluralities of clips 217 and 218 may be mounted to outer door panel 220, and first and second pluralities of holes 223 and 224 may be defined by inner door panel 210. As another example, first and second flanges 224 and 225 may extend along the transverse direction T such that first and second pluralities of holes 223 and 224 are defined within first and second flanges 224 and 225 rather than through first and second flanges 224 and 225. In particular, first and second flanges 224 and 225 may include a plastic stud mounted (e.g., using glue) to first and second sidewalls 221 and 222 respectively.

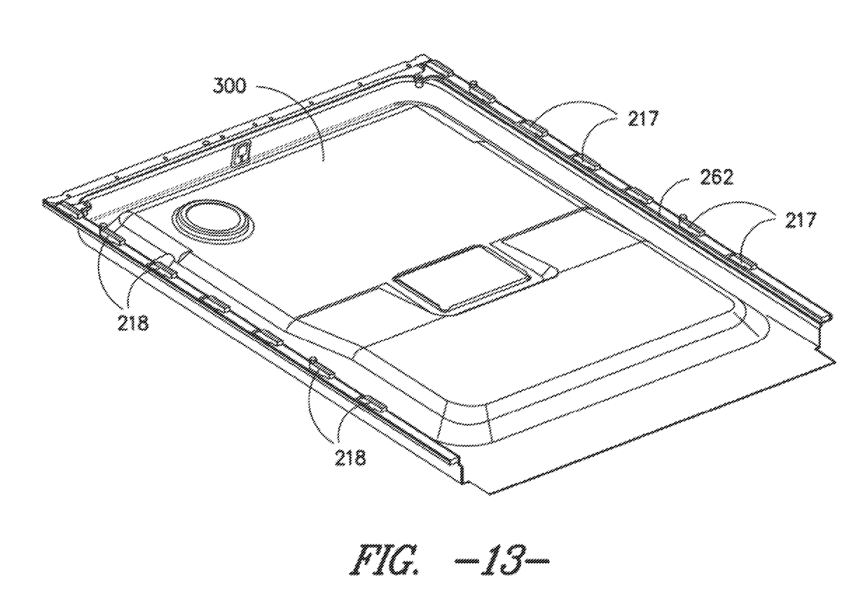

FIGS. 12 and 13 illustrate rear perspective views of another exemplary embodiment of an inner door panel 300 Inner door panel 300 is substantially similar to inner door panel 210. However, as discussed above, first and second pluralities of clips 217 and 218 are integral with inner door panel 210. However, inner door panel 300 is constructed such that first and second pluralities of clips 217 and 218 are separate components mounted to inner door panel 300.

As may be seen in FIG. 12, first plurality of clips 217 is connected with a web 262. Web 262 extends between and connects each clip of the first plurality of clips 217. In addition, inner door panel 300 (e.g., a sidewall of inner door panel 300) defines a channel 260 and gaps 261 for receiving first plurality of clips 217. Thus, as may be seen in FIG. 13, first plurality of clips 217 may be mounted to inner door panel 300 by positioning web 262 within channel 260 and each one of the first plurality of clips within a respective one of the gaps 261.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A door assembly for an appliance, comprising:
an outer door panel defining a first plurality of holes and a second plurality of holes, the first plurality of holes being dispersed on a first side of said outer door panel along a vertical direction, the second plurality of holes being dispersed on a second side of said outer door panel along the vertical direction;
an inner door panel;
a first plurality of clips mounted on a first side of said inner door panel, said first plurality of clips being dispersed along the vertical direction such that each one of said first plurality of clips is received within a respective one of the first plurality of holes of said outer door panel; and
a second plurality of clips mounted on a second side of said inner door panel, said second plurality of clips being dispersed along the vertical direction such that each one of said second plurality of clips is received within a respective one of the second plurality of holes of said outer door panel.

2. The door assembly of claim 1, wherein said outer door panel comprises:
a first sidewall mounted to the first side of said outer door panel, said first sidewall extending from the first side of said outer door panel along a transverse direction;
a first flange extending from said first sidewall along a horizontal direction, said first flange defining the first plurality of holes, the first plurality of holes being dispersed on said first flange along the vertical direction;
a second sidewall mounted to the second side of said outer door panel, said second sidewall extending from the second side of said outer door panel along the transverse direction; and
a second flange extending from said second sidewall along the horizontal direction, said second flange defining the second plurality of holes, the second plurality of holes being dispersed on said second flange along the vertical direction.

3. The door assembly of claim 2, wherein an outer surface of said inner door panel is disposed closer to said outer door panel along the transverse direction than a distal end of said first sidewall and a distal end of said second side wall.

4. The door assembly of claim 1, wherein said first and second plurality of clips are integrally molded to said inner door panel.

5. The door assembly of claim 4, wherein said inner door panel is constructed of a plastic.

6. The door assembly of claim 1, wherein said first plurality of clips are received within a first plurality of gaps defined by said first flange and said second plurality of clips are received within a second plurality of gaps defined by said second flange.

7. The door assembly of claim 6, wherein said inner door panel is constructed of a metal.

8. The door assembly of claim 1, further comprising a control panel mounted to said inner door panel at a top of said inner door panel, a top of said outer door panel positioned adjacent a bottom of said control panel.

9. The door assembly of claim 1, wherein said outer door panel defines a handle recess at a top of said outer door panel.

10. The door assembly of claim 1, further comprising a hinge mounted to said outer door panel at a bottom of said outer door panel.

11. A dishwasher appliance, comprising:
a tub defining a wash chamber for receipt of articles for cleaning;
a door assembly mounted to said tub and configured for permitting selective access to the wash chamber of said tub, said door assembly comprising:
an outer door panel having a first side and a second side spaced apart along a horizontal direction;
a first flange positioned at the first side of said outer door panel, said first flange spaced apart from said outer door panel along a transverse direction, said first flange defining a first plurality of holes; and
a second flange positioned at the second side of said outer door panel, said second flange spaced apart from said outer door panel along the transverse direction, said second flange defining a second plurality of holes;
an inner door panel having a first side and a second side spaced apart along the horizontal direction;
a first plurality of clips mounted on the first side of said inner door panel in a complementary manner to the first plurality of holes of said first flange;
a second plurality of clips mounted on the second side of said inner door panel in a complementary manner to the second plurality of holes of said second flange, wherein each one of said first plurality of clips is configured for receipt within a respective one of the first plurality of holes of said first flange and each one of said second plurality of clips is configured for receipt within a respective one of the second plurality of holes of said second flange in order to mount said inner door panel to said outer door panel.

12. The dishwasher appliance of claim 11, wherein said first and second pluralities of clips are integrally molded to said inner door panel.

13. The dishwasher appliance of claim 12, wherein said inner door panel is constructed of a plastic.

14. The dishwasher appliance of claim 11, wherein said first plurality of clips are received within a first plurality of gaps defined by said first flange and said second plurality of clips are received within a second plurality of gaps defined by said second flange.

15. The dishwasher appliance of claim 14, wherein said inner door panel is constructed of a metal.

16. The dishwasher appliance of claim 11, wherein an outer surface of said inner door panel is disposed closer to said outer door panel along the transverse direction than a distal end of said first sidewall and a distal end of said second side wall.

17. The dishwasher appliance of claim 11, wherein said door assembly further comprises a control panel mounted to said inner door panel at a top of said inner door panel, a top of said outer door panel positioned immediately adjacent a bottom of said control panel.

18. The dishwasher appliance of claim 11, wherein said outer door panel defines a handle recess at a top of said outer door panel.

19. The dishwasher appliance of claim 11, wherein said door assembly further comprises a hinge mounted to said outer door panel at a bottom of said outer door panel, said hinge rotatably mounting said door assembly to said tub, said hinge rotatably mounting said door assembly to said tub.

20. A door assembly for an appliance, comprising:
an inner door panel defining a first plurality of holes and a second plurality of holes, the first plurality of holes being dispersed on a first side of said inner door panel along a vertical direction, the second plurality of holes being dispersed on a second side of said inner door panel along the vertical direction;
an outer door panel;
a first plurality of clips mounted on a first side of said outer door panel, said first plurality of clips being dispersed along the vertical direction such that each one of said first plurality of clips is received within a respective one of the first plurality of holes of said inner door panel; and
a second plurality of clips mounted on a second side of said outer door panel, said second plurality of clips being dispersed along the vertical direction such that each one of said second plurality of clips is received within a respective one of the second plurality of holes of said inner door panel.
